(19) United States
(12) Patent Application Publication
(10) Pub. No.: US 2025/0094793 A1
(43) Pub. Date: Mar. 20, 2025

(54) RE-ARRANGING FEED FORWARD NETWORKS (FFNs) IN TRANSFORMER-BASED MODELS

(71) Applicant: QUALCOMM Incorporated, San Diego, CA (US)

(72) Inventors: Manish Kumar SINGH, San Diego, CA (US); Tianyu JIANG, San Diego, CA (US); Hsin-Pai CHENG, San Diego, CA (US); Kartikeya BHARDWAJ, San Diego, CA (US); Hong CAI, San Diego, CA (US); Mingu LEE, San Diego, CA (US); Munawar HAYAT, San Diego, CA (US); Christopher LOTT, San Diego, CA (US); Fatih Murat PORIKLI, San Diego, CA (US)

(21) Appl. No.: 18/469,909

(22) Filed: Sep. 19, 2023

(51) Int. Cl. G06N 3/0499

(52) U.S. Cl. CPC G06N 3/0499

(57) ABSTRACT

A processor-implemented method for image or text processing includes receiving, by an artificial neural network (ANN) model, a set of tokens corresponding to an input. A token interaction block of the ANN model processes the set of tokens according to each channel of the input to generate a spatial mixture of a set of features for each channel of the input. A feed forward network block of the ANN model generates a mixture of channel features based on the spatial mixture of the set of features for each channel of the input. An attention block of the ANN model determines a set of attended features of the mixture of channel features according to a set of attention weights. In turn, the ANN model generates an inference based on the set of attend features of the mixture of channel features.

### FIELD OF THE DISCLOSURE

Aspects of the present disclosure generally relate to artificial neural networks, and more specifically to transformer-based models.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Edge devices such as smartphones are widely used. Given the many useful applications of neural networks, there is increasing demand for use of edge devices and for personalized services for such edge devices. However, edge devices have limited computational resources and generalized models may utilize more complex networks and computational resources.

Transformer-based architectures have become the de-facto standard models for a wide range of natural language processing tasks. However, their memory footprint and high latency are prohibitive for efficient deployment and inference on resource-limited devices.

### SUMMARY

The present disclosure is set forth in the independent claims, respectively. Some aspects of the disclosure are described in the dependent claims.

In some aspects of the present disclosure, a processor-implemented method performed by one or more processors includes receiving, by an artificial neural network (ANN) model, a set of tokens corresponding to an input. The processor-implemented method also includes processing, by a token interaction block of the ANN model, the set of tokens according to each channel of the input to generate a spatial mixture of a set of features for each channel of the input. The processor-implemented method additionally includes generating, by a feed forward network (FFN) block of the ANN model, a mixture of channel features based on the spatial mixture of the set of features for each channel of the input. The processor-implemented method further includes determining, by an attention block of the ANN model, a set of attended features of the mixture of channel features according to a set of attention weights. The processor-implemented method still further includes generating, by the ANN model, an inference based on the set of attend features of the mixture of channel features.

Various aspects of the present disclosure are directed to an apparatus including means for receiving, by an artificial neural network (ANN) model, a set of tokens corresponding to an input. The apparatus also includes means for processing, by a token interaction block of the ANN model, the set of tokens according to each channel of the input to generate a spatial mixture of a set of features for each channel of the input. The apparatus further includes means for generating, by a feed forward network (FFN) block of the ANN model, a mixture of channel features based on the spatial mixture of the set of features for each channel of the input. The apparatus additionally includes means for determining, by an attention block of the ANN model, a set of attended features of the mixture of channel features according to a set of attention weights. The apparatus further still includes means for generating, by the ANN model, an inference based on the set of attend features of the mixture of channel features.

In some aspects of the present disclosure, a non-transitory computer-readable medium with non-transitory program code recorded thereon is disclosed. The program code is executed by a processor and includes program code to receive, by an artificial neural network (ANN) model, a set of tokens corresponding to an input. The program code also includes program code to process, by a token interaction block of the ANN model, the set of tokens according to each channel of the input to generate a spatial mixture of a set of features for each channel of the input. The program code additionally includes program code to generate, by a feed forward network (FFN) block of the ANN model, a mixture of channel features based on the spatial mixture of the set of features for each channel of the input. The program code further includes program code to determine, by an attention block of the ANN model, a set of attended features of the mixture of channel features according to a set of attention weights. The program code still further includes program code to generate, by the ANN model, an inference based on the set of attend features of the mixture of channel features.

Another aspect of the present disclosure is directed to an apparatus having at least one memory and one or more processors coupled to the at least one memory. The processor(s) is configured to receive, by an artificial neural network (ANN) model, a set of tokens corresponding to an input. The processor(s) is also configured to process, by a token interaction block of the ANN model, the set of tokens according to each channel of the input to generate a spatial mixture of a set of features for each channel of the input. The processor(s) is additionally configured to generate, by a feed forward network (FFN) block of the ANN model, a mixture of channel features based on the spatial mixture of the set of features for each channel of the input. The processor(s) is further configured to determine, by an attention block of the ANN model, a set of attended features of the mixture of channel features according to a set of attention weights. Furthermore, the processor(s) is configured to generate, by the ANN model, an inference based on the set of attend features of the mixture of channel features.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary software architecture that may modularize artificial intelligence (AI) functions, in accordance with various aspects of the present disclosure.

FIGS. 4A and 4B are a block diagrams illustrating a conventional vision transformer and a conventional transformer encoder.

FIG. 4C is a high-level block diagram further illustrating the conventional transformer encoder of FIGS. 4A and 4B.

FIG. 5 is a block diagram illustrating an example architecture of a transformer encoder, in accordance with aspects of the present disclosure.

FIG. 6 is a flow diagram illustrating a processor-implemented method for generating an inference using an artificial neural network (ANN) including a transformer, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on the conventional transformer architectures such as (but not limited to) bi-directional encoder representations from transformers (BERT), robustly optimized BERT approach (ROBERTa), XLNet, Transformer-XL, and the generative pre-trained transformer (GPT) family of transformers (e.g., GPT-2, GPT-3, GPT-4, etc.), language models may be pre-trained with a large corpora of unlabeled text. Accordingly, such transformer architectures have become popular building blocks in conventional NLP pipelines, as well as in other areas such as computer vision and audio processing.

Vision transformers (ViTs) are widely used for computer vision tasks such as classification, detection, segmentation, and depth estimation, for example. Vision transformers apply transformer architecture directly to images. Rather than process tokens including portions (words) of text or audio sequences, vision transformers split an image into patches and treat the patches as tokens in an NLP application.

Despite providing performance improvements in many applications, pre-trained transformer-based models may be extremely large, sometimes exceeding billions of parameters, for example. Hence, efficient deployment of such transformer-based models on resource-constrained embedded systems including mobile devices (e.g., smartphones) and Internet of Things (IoT) devices, and even some systems in data centers, is challenging due to increased latency, energy consumption, and a prohibitively large memory footprint.

Moreover, improving transformer accuracy of such transformer architectures may involve stacking more layers into the transformer-based model. However, stacking more layers results in increased computation and model latency.

To address these and other issues, aspects of the present disclosure are directed to rearranging feed forward networks (FFNs) of a transformer-based model. In some aspects, the FFN may be adapted and may include a multilayer perceptron operation on the channel dimension of a feature map. The FFN may be implemented using point-wise convolutions. The FFN may also include a token interaction block to provide spatial mixing of input features. The token interaction block may be implemented using depth-wise convolutions, for example.

Particular aspects of the subject matter described in this disclosure can be implemented to realize one or more of the following potential advantages. In some examples, the described techniques (e.g., redistributing parameters of the FFN and incorporating the token interaction module for spatial mixing of input features) may enable increasing of model accuracy without increasing computations.

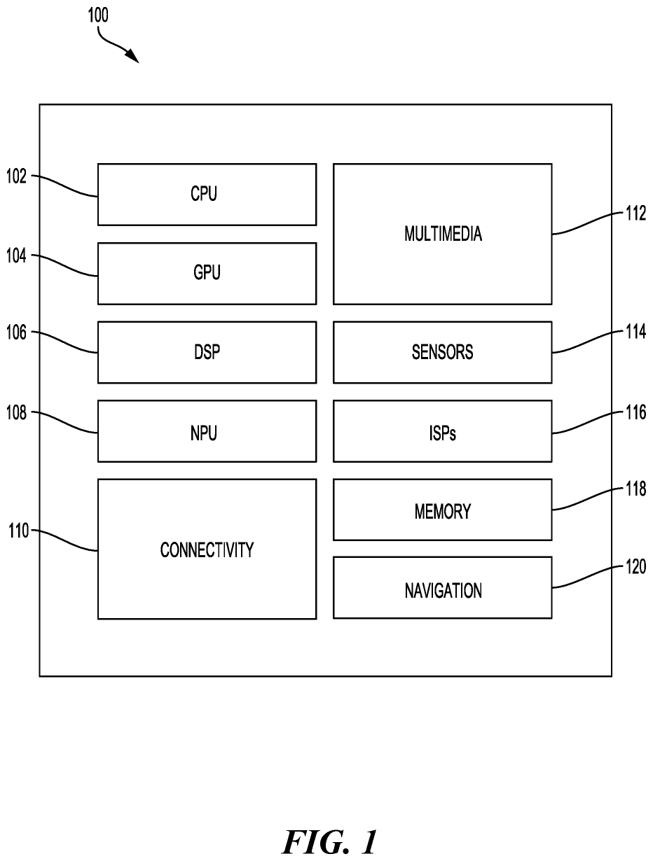

FIG. 1 illustrates an example implementation of a system-on-a-chip (SOC) 100, which may include a central processing unit (CPU) 102 or a multi-core CPU configured for image, textual and/or audio processing using transformer-based models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, by an artificial neural network (ANN) model, a set of tokens corresponding to an input. The instructions loaded into the general-purpose processor 102 may also include code to process, by a token interaction block of the ANN model, the set of tokens according to each channel of the input to generate a spatial mixture of a set of features for each channel of the input. The instructions loaded into the general-purpose processor 102 may additionally include code to generate, by a feed forward network (FFN) block of the ANN model, a mixture of channel features based on the spatial mixture of the set of features for each channel of the input. The instructions loaded into the general-purpose processor 102 may further include code to determine, by an attention block of the ANN model, a set of attended features of the mixture of channel features according to a set of attention weights. Furthermore, the instructions loaded into the general-purpose processor 102 may include code to generate, by the ANN model, an inference based on the set of attend features of the mixture of channel features.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed forward networks, information is passed from lower to higher layers, with each neuron in a given layer communicating to neurons in higher layers. A hierarchical representation may be built up in successive layers of a feed forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

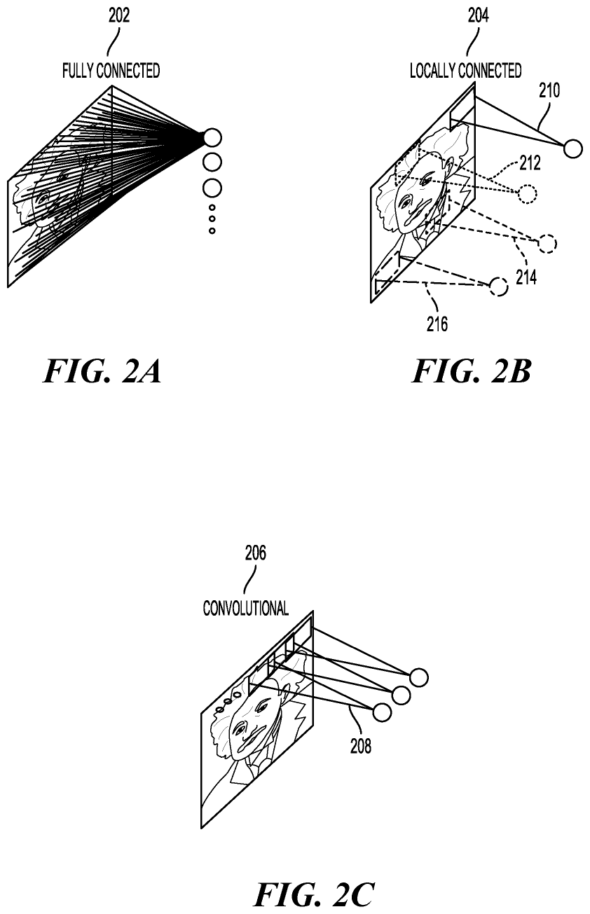

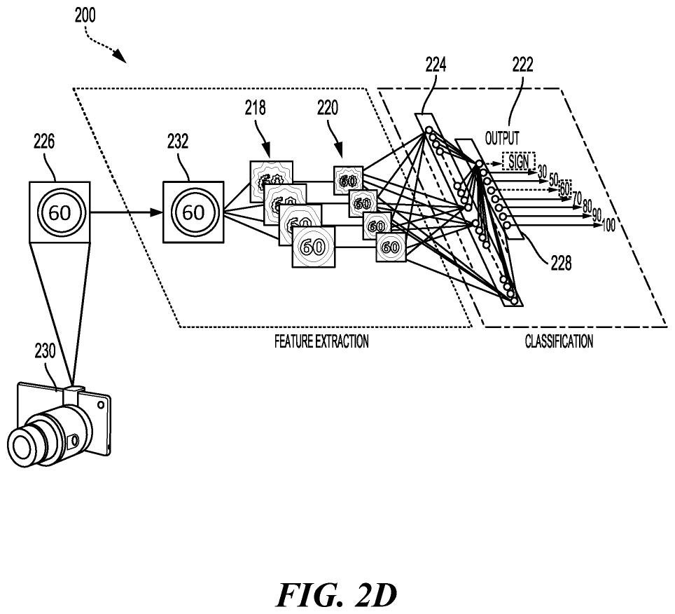

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolution kernels (not shown) to the image 226 to generate a first set of feature maps 218. As an example, the convolution kernel for the convolutional layer 232 may be a 5×5 kernel that generates 28×28 feature maps. In the present example, because four different feature maps are generated in the first set of feature maps 218, four different convolution kernels were applied to the image 226 at the convolutional layer 232. The convolution kernels may also be referred to as filters or convolution filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed forward networks. In addition, as described above, the connections from a neuron in a first layer of a DCN to a group of neurons in the next higher layer are shared across the neurons in the first layer. The feed forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

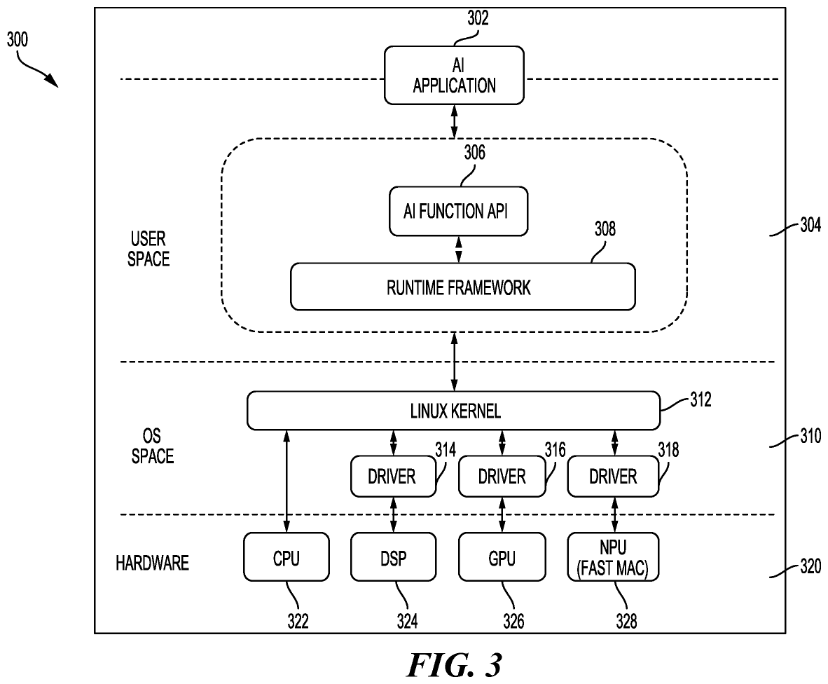

FIG. 3 is a block diagram illustrating an exemplary software architecture 300 that may modularize artificial intelligence (AI) functions. Using the architecture 300, applications may be designed that may cause various processing blocks of a system-on-a-chip (SoC) 320 (for example a CPU 322, a DSP 324, a GPU 326 and/or an NPU 328) (which may be similar to SoC 100 of FIG. 1) to support language processing or image processing for an AI application 302, according to aspects of the present disclosure. The architecture 300 may, for example, be included in a computational device, such as a smartphone.

The AI application 302 (e.g., an AI application) may be configured to call functions defined in a user space 304 that may, for example, provide for the detection and recognition of a scene indicative of the location at which the computational device including the architecture 300 currently operates. The AI application 302 may, for example, configure a microphone and a camera differently depending on whether the recognized scene is an office, a lecture hall, a restaurant, or an outdoor setting such as a lake. The AI application 302 may make a request to compiled program code associated with a library defined in an AI function application programming interface (API) 306. This request may ultimately rely on the output of a deep neural network configured to provide an inference response based on video and positioning data, for example.

A run-time engine 308, which may be compiled code of a runtime framework, may be further accessible to the AI application 302. The AI application 302 may cause the run-time engine 308, for example, to request an inference at a particular time interval or triggered by an event detected by the user interface of the AI application 302. When caused to provide an inference response, the run-time engine 308 may in turn send a signal to an operating system in an operating system (OS) space, such as a Linux Kernel 312, running on the SoC 320. The operating system, in turn, may cause a continuous relaxation of quantization to be performed on the CPU 322, the DSP 324, the GPU 326, the NPU 328, or some combination thereof. The CPU 322 may be accessed directly by the operating system, and other processing blocks may be accessed through a driver, such as a driver 314, 316, or 318 for, respectively, the DSP 324, the GPU 326, or the NPU 328. In the exemplary example, the deep neural network may be configured to run on a combination of processing blocks, such as the CPU 322, the DSP 324, and the GPU 326, or may be run on the NPU 328.

As described, aspects of the present disclosure are directed to rearranging feed forward networks (FFNs) of a transformer-based model. In some aspects, the FFN may be adapted and may include a multilayer perceptron operation on the channel dimension of a feature map. The FFN may be implemented using point-wise convolutions. The FFN may also include a token interaction block to provide spatial mixing of input features. The token interaction block may be implemented using depth-wise convolutions, for example.

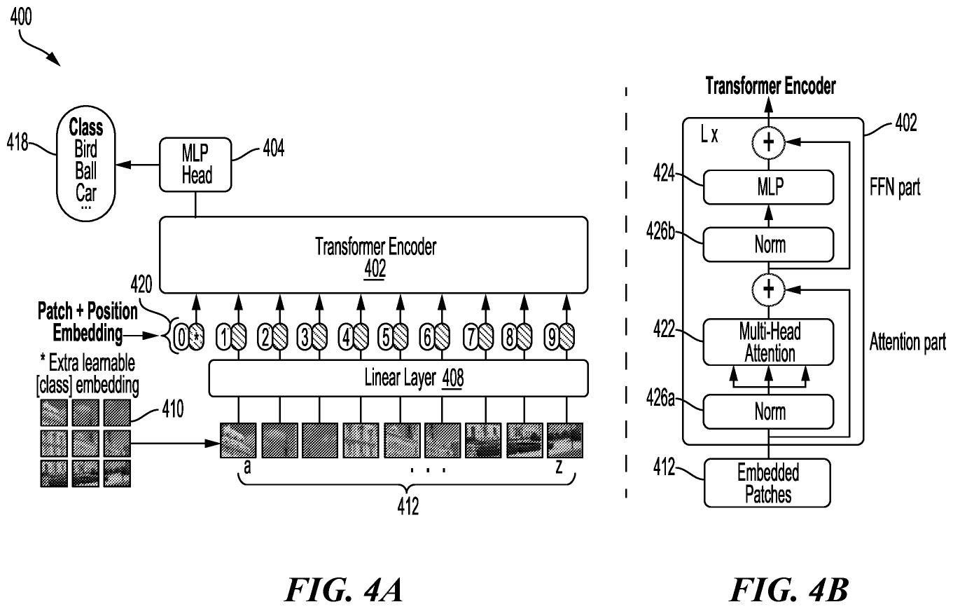

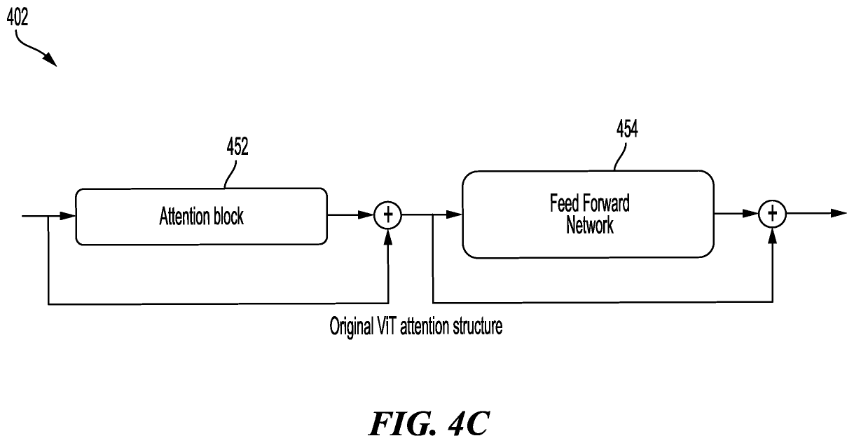

FIGS. 4A and 4B are a block diagrams illustrating a conventional vision transformer 400 and a conventional transformer encoder 402. Referring to FIG. 4A, the conventional vision transformer 400 includes the conventional transformer encoder 402 and a multilayer perceptron (MLP) head 404.

The conventional vision transformer 400 may operate in a manner similar to transformers in natural language processing applications. That is, the conventional vision transformer 400 may split an input image 410 (shown split into patches of pixels) into multiple patches 412a-z (collectively referred to as image patches 412) that may be treated as tokens (e.g., words). The image patches are supplied to a linear layer 408, which generates a sequence of linear embeddings. Positional embeddings may be added to the linear embeddings to form patch and positional embeddings 420, which may be provided to the conventional transformer encoder 402.

The conventional transformer encoder 402 processes the patch and positional embeddings 420 to determine relationships between the patch and positional embeddings 420 and generates an output. The output is provided to the MLP head 404, which generates a classification 418 for the input image 410.

FIG. 4B shows an expanded view of the conventional transformer encoder 402. The conventional transformer encoder 402 includes alternating layers of multi-head attention blocks 422 and MLP blocks 424. A layer norm block 426 (e.g., 426a, 426b) may be applied before every block of the conventional transformer encoder 402. The multi-head attention blocks 422 and MLP blocks 424 may each include a residual connection.

FIG. 4C is a high-level block diagram further illustrating the conventional transformer encoder 402 of FIGS. 4A and 4B. The conventional transformer encoder 402 may be considered as having an alternating block structure including an attention block 452 and a feed forward network block 454. The attention block 452 and the feed forward network block 454 each have residual connections. The attention block 452 includes the multi-head attention block 422 shown in FIG. 4B. The feed forward network block 454 includes the MLP block 424, also shown in FIG. 4B.

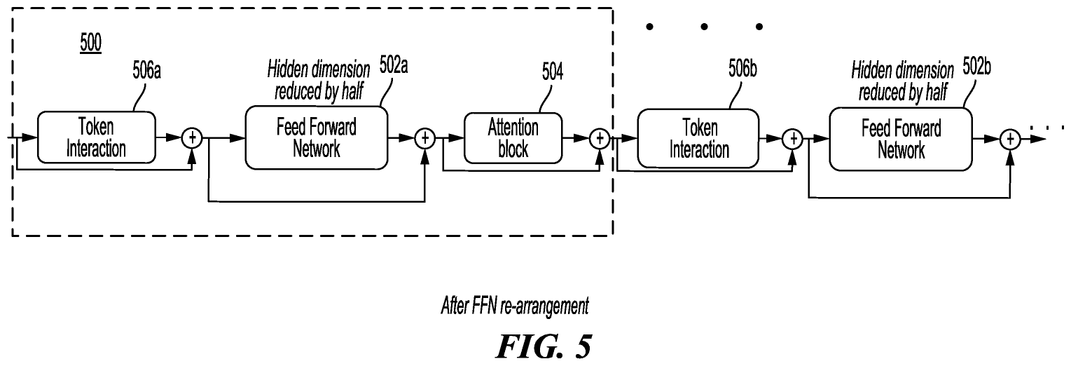

FIG. 5 is a block diagram illustrating an example architecture of a transformer encoder 500, in accordance with aspects of the present disclosure. Referring to FIG. 5, the example transformer encoder 500 may include a feed forward network (FFN) block 502a, an attention block 504, and a token interaction block 506a. In some aspects, the example transformer encoder 500 may include one or more normalization layers (e.g., 426b of FIG. 4).

In various aspects of the present disclosure, one or more example transformer encoders 500 may be included in an ANN. For instance, as shown in FIG. 5, transformer encoders 500 may be arranged to sequentially process the input. The token interaction blocks 506a, 506b (collectively referred to as token interaction block 506) may be interleaved between pairs of FFN block (e.g., 502a, 502b) and the attention block 504. The token interaction block 506a may receive as an input, embeddings corresponding to input tokens (e.g., words or image patches). The input tokens may correspond to an input such as an image, speech input, sequence of text or other sequential data, for example. Such inputs may be pre-processed in a manner similar to that of other natural language processing applications. That is, the inputs may be divided into one or more tokens (e.g., words or image patches), which may, in turn, be processed by a linear layer (e.g., 408) to generate the embeddings. In some aspects, positional information may also be incorporated into embeddings.

The token interaction block 506 may be configured to process the embeddings corresponding to the input tokens by performing a spatial mixing of features of input tokens. In various aspects of the present disclosure, the token interaction blocks 506 may be implemented using a depth-wise convolution operation. However, the present disclosure is not so limiting. Rather, the token interaction blocks 506 may be implemented with any operation that allows spatial mixing of the input features, including (but not limited to) convolution or grouped convolution, for example.

In depth-wise convolution, a separable convolution filter (may also be referred to as a convolution kernel) may be applied to each channel of the input (e.g., 410 in FIG. 4A). In some examples, where the input comprises an image (e.g., 410 in FIG. 4A), the token interaction block 506 may receive as input two-dimensional (2D) features (e.g., in the form of a feature map) including image patches/tokens. The token interaction blocks 506 may perform the spatial mixing of input features using depth-wise convolutions for each channel of an input (e.g., features of the patch/positional embeddings). The token interaction blocks 506 may provide the spatial mixture of input features for each channel to the FFN blocks 502.

The FFN blocks 502a, 502b (collectively referred to as FFN block 502) may each comprise (but are not limited to) an MLP, for example. The FFN block 502 may operate on the channel dimension of a feature map corresponding to the input (e.g., 410). In various aspects, the FFN block 502 may be implemented using point-wise convolutions, for example. A point-wise convolution may use a 1×1 convolution kernel that iterates through every point of an input (e.g., an output of the token interaction blocks 506).

The FFN block 502 may receive the spatial mixture of the input features for each channel of the input. The FFN block 502 may process the spatial mixture of the input features for each channel of the input using one or more hidden layers. For example, the FFN block 502 may receive an output from the token interaction block 506 which may be in the form of a two-dimensional (2D) visual feature map. The FFN block 502 may perform the point-wise convolution to mix the spatial mixture of input features between the different channel of the input to generate a mixture of channel features. In some aspects, the FFN block 502 may generate an output that may have the same dimensions as the input (e.g., 410), but with the channel features/values mixed.

The output of the FFN block 502 may be provided to the attention block 504. In various aspects, a reshape operation may be applied to the 2D feature map to re-arrange the image patches/tokens into the form of a one-dimensional (1D) sequence, which may then be readily consumed by the attention block 504. The attention block 504 may implement self-attention or multi-head attention to determine relationships among the channel and spatially mixed features. That is, the attention block 504 may assign different attention weights to different portions of the mixture of channel features, which may then be used to generate an output inference.

Incorporating the token interaction block 506 to provide the spatial mixing of input features before the FFN block 502 may increase the accuracy of the example transformer encoder 500, in comparison to the conventional transformer encoder 402, without additional layers and increased computation. In some examples, the dimensions of hidden layers within the FFN block 502 may be reduced, and in some aspects, may be reduced by fifty percent (or other amount). By changing the number of hidden dimensions in the FFN block 502, the number of parameters in the transformer encoder 500 and an ANN model included the transformer encoder 500 may be controlled. In addition, unlike the conventional transformer encoder 402 which has just one FFN block (e.g., 424) after the attention block (e.g., 422), the parameters of transformer encoder 500 may be reallocated in multiple FFN blocks 502 (e.g., both before and after the attention block 504).

Furthermore, in various aspects of the present disclosure, the output of the attention blocks 504 may be provided to additional transformer encoders blocks (e.g., 500) to further improve the inference accuracy.

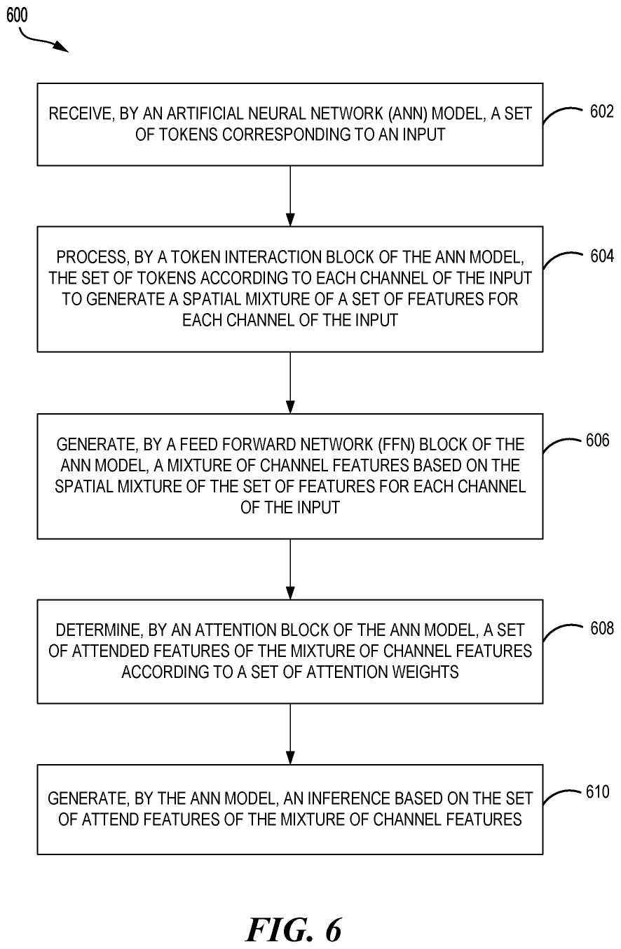

FIG. 6 is a flow diagram illustrating a processor-implemented method 600 for generating an inference using an artificial neural network (ANN) including a transformer, in accordance with various aspects of the present disclosure. The processor-implemented method 600 may be performed by a processor such as the CPU (e.g., 102, 322), the GPU (e.g., 104, 326), and/or other processing units (e.g., DSP 324 or NPU 328), for example.

As shown in FIG. 6, at block 602, the processor receives, by an artificial neural network (ANN) model, a set of tokens corresponding to an input. The ANN model may comprise (but is not limited to) a transformer architecture. In some aspects, the transformer architecture may include bi-directional encoder representations from transformers (BERT), robustly optimized BERT approach (ROBERTa), XLNet, Transformer-XL, the generative pre-trained transformer (GPT) family of transformers (e.g., GPT-2, GPT-3, GPT-4, etc.) or a vision transformer.

As described with reference to FIG. 5, each transformer encoder 500 may include a feed forward network (FFN) block 502a, an attention block 504, and a token interaction block 506a. The token interaction block 506a may receive as an input, embeddings corresponding to input tokens (e.g., words or image patches). The input tokens may correspond to an input such as an image, speech input, sequence of text or other sequential data, for example. The inputs may be split into one or more tokens (e.g., words or image patches), which may in turn be processed by a linear layer (e.g., 408) to generate the embeddings. In some aspects, positional information may also be incorporated into embeddings.

At block 604, the processor processes, by a token interaction block of the ANN model, the set of tokens according to each channel of the input to generate a spatial mixture of a set of features for each channel of the input. As described, for example with reference to FIG. 5, the token interaction block 506 may be configured to process the embeddings corresponding to the input tokens by performing a spatial mixing of features of input tokens. The token interaction block 506 may be implemented using a depth-wise convolution operation for example. In some examples, where the input comprises an image, the token interaction block 506 may receive as input two-dimensional (2D) features (e.g., in the form of a feature map) including image patches/tokens. The token interaction block 506 may perform the spatial mixing of input features using depth-wise convolutions for each channel of an input (e.g., features of the patch/positional embeddings). The token interaction block 506 may provide the spatial mixture of input features for each channel to the FFN block 502.

At block 606, the processor generates, by a feed forward network (FFN) block of the ANN model, a mixture of channel features based on the spatial mixture of the set of features for each channel of the input. For instance, as described with reference to FIG. 5, the FFN block 502 may receive the spatial mixture of the input features for each channel of the input. The FFN block 502 may perform a point-wise convolution to mix the spatial mixture of input features between the different channel of the input to generate a mixture of channel features.

At block 608, the processor determines, by an attention block of the ANN model, a set of attended features of the mixture of channel features according to a set of attention weights. As described, for example, with reference to FIG. 5, the output of the FFN block 502 may be provided to the attention block 504. In various aspects, a reshape operation may be applied to the 2D feature map to re-arrange the image patches/tokens into the form of a one dimensional (1D) sequence, which may then be readily consumed by the attention block 504. The attention block 504 may assign different attention weights to different portions of the mixture of channel features.

At block 610, the processor generates, by the ANN model, an inference based on the set of attend features of the mixture of channel features.

Implementation examples are provided in the following numbered clauses.
1. A processor-implemented method performed by one or more processors, the processor-implemented method comprising:
   receiving, by an artificial neural network (ANN) model, a set of tokens corresponding to an input;
   processing, by a token interaction block of the ANN model, the set of tokens according to each channel of the input to generate a spatial mixture of a set of features for each channel of the input;
   generating, by a feed forward network (FFN) block of the ANN model, a mixture of channel features based on the spatial mixture of the set of features for each channel of the input;
   determining, by an attention block of the ANN model, a set of attended features of the mixture of channel features according to a set of attention weights; and
   generating, by the ANN model, an inference based on the set of attend features of the mixture of channel features.
2. The processor-implemented method of claim 1, further comprising processing the set of tokens corresponding to the input using a depth-wise convolution to generate the spatial mixture of the set of features.
3. The processor-implemented method of clause 1 or 2, further comprising processing the spatial mixture of the set of features using a point-wise convolution to generate the mixture of channel features.
4. The processor-implemented method of any of clauses 1-3, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).
5. The processor-implemented method of any of clauses 1-4, in which the input comprises an image, an audio signal, or a textual input.
6. The processor-implemented method of any of clauses 1-5, in which the image is divided into a set of patches, the set of tokens corresponding to the set of patches of the image.
7. The processor-implemented method of any of clauses 1-6, in which the inference is a classification of the input.
8. The processor-implemented method of any of clauses 1-7, further comprising reshaping the mixture of channel features to form a one-dimensional sequence of mixed features.
9. An apparatus, comprising:
   at least one memory; and
   at least one processor coupled to the at least one memory, the at least one processor configured to:
      receive, by an artificial neural network (ANN) model, a set of tokens corresponding to an input;
      process, by a token interaction block of the ANN model, the set of tokens according to each channel of the input to generate a spatial mixture of a set of features for each channel of the input;
      generate, by a feed forward network (FFN) block of the ANN model, a mixture of channel features based on the spatial mixture of the set of features for each channel of the input;
      determine, by an attention block of the ANN model, a set of attended features of the mixture of channel features according to a set of attention weights; and
      generate, by the ANN model, an inference based on the set of attend features of the mixture of channel features.
10. The apparatus of clause 9, in which the at least one processor is further configured to process the set of tokens corresponding to the input using a depth-wise convolution to generate the spatial mixture of the set of features.
11. The apparatus of clause 9 or 10, in which the at least one processor is further configured to process the spatial mixture of the set of features using a point-wise convolution to generate the mixture of channel features.
12. The apparatus of any of clauses 9-11, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).
13. The apparatus of any of clauses 9-12, in which the input comprises an image, an audio signal, or a textual input.
14. The apparatus of any of clauses 9-13, in which the at least one processor is further configured to divide the image into a set of patches, the set of tokens corresponding to the set of patches of the image.
15. The apparatus of any of clauses 9-14, in which the inference is a classification of the input.
16. The apparatus of any of clauses 9-15, in which the at least one processor is further configured to reshape the mixture of channel features to form a one-dimensional sequence of mixed features.
17. A non-transitory computer-readable medium having program code recorded thereon, the program code executed by a processor and comprising:
   program code to receive, by an artificial neural network (ANN) model, a set of tokens corresponding to an input;
   program code to process, by a token interaction block of the ANN model, the set of tokens according to each channel of the input to generate a spatial mixture of a set of features for each channel of the input;
   program code to generate, by a feed forward network (FFN) block of the ANN model, a mixture of channel features based on the spatial mixture of the set of features for each channel of the input;
   program code to determine, by an attention block of the ANN model, a set of attended features of the mixture of channel features according to a set of attention weights; and
   program code to generate, by the ANN model, an inference based on the set of attend features of the mixture of channel features.
18. The non-transitory computer-readable medium of clause 17, in which the program code comprises program code to process the set of tokens corresponding to the input using a depth-wise convolution to generate the spatial mixture of the set of features.
19. The non-transitory computer-readable medium of clause 17 or 18, in which the program code comprises program code to process the spatial mixture of the set of features using a point-wise convolution to generate the mixture of channel features.
20. The non-transitory computer-readable medium of any of clauses 17-19, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).
21. The non-transitory computer-readable medium of any of clauses 17-20, in which the input comprises an image, an audio signal, or a textual input.
22. The non-transitory computer-readable medium of any of clauses 17-21, in which the program code comprises program code to divide the image into a set of patches, the set of tokens corresponding to the set of patches of the image.
23. The non-transitory computer-readable medium of any of clauses 17-22, in which the program code comprises program code to reshape the mixture of channel features to form a one-dimensional sequence of mixed features.
24. An apparatus comprising:
   means for receiving, by an artificial neural network (ANN) model, a set of tokens corresponding to an input;
   means for processing, by a token interaction block of the ANN model, the set of tokens according to each channel of the input to generate a spatial mixture of a set of features for each channel of the input;
   means for generating, by a feed forward network (FFN) block of the ANN model, a mixture of channel features based on the spatial mixture of the set of features for each channel of the input;
   means for determining, by an attention block of the ANN model, a set of attended features of the mixture of channel features according to a set of attention weights; and
   means for generating, by the ANN model, an inference based on the set of attend features of the mixture of channel features.
25. The apparatus of clause 24, further comprising means for processing the set of tokens corresponding to the input using a depth-wise convolution to generate the spatial mixture of the set of features.
26. The apparatus of clause 24 or 25, further comprising means for processing the spatial mixture of the set of features using a point-wise convolution to generate the mixture of channel features.
27. The apparatus of any of clauses 24-26, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).
28. The apparatus of any of clauses 24-27, in which the input comprises an image, an audio signal, or a textual input.
29. The apparatus of any of clauses 24-28, further comprising means for dividing the image into a set of patches, the set of tokens corresponding to the set of patches of the image.
30. The apparatus of any of clauses 24-29, further comprising means for reshaping the mixture of channel features to form a one-dimensional sequence of mixed features.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method performed by one or more processors, the processor-implemented method comprising:
receiving, by an artificial neural network (ANN) model, a set of tokens corresponding to an input;
processing, by a token interaction block of the ANN model, the set of tokens according to each channel of the input to generate a spatial mixture of a set of features for each channel of the input;
generating, by a feed forward network (FFN) block of the ANN model, a mixture of channel features based on the spatial mixture of the set of features for each channel of the input;
determining, by an attention block of the ANN model, a set of attended features of the mixture of channel features according to a set of attention weights; and
generating, by the ANN model, an inference based on the set of attend features of the mixture of channel features.

2. The processor-implemented method of claim 1, further comprising processing the set of tokens corresponding to the input using a depth-wise convolution to generate the spatial mixture of the set of features.

3. The processor-implemented method of claim 1, further comprising processing the spatial mixture of the set of features using a point-wise convolution to generate the mixture of channel features.

4. The processor-implemented method of claim 1, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).

5. The processor-implemented method of claim 1, in which the input comprises an image, an audio signal, or a textual input.

6. The processor-implemented method of claim 5, in which the image is divided into a set of patches, the set of tokens corresponding to the set of patches of the image.

7. The processor-implemented method of claim 1, in which the inference is a classification of the input.

8. The processor-implemented method of claim 1, further comprising reshaping the mixture of channel features to form a one-dimensional sequence of mixed features.

9. An apparatus, comprising:
at least one memory; and
at least one processor coupled to the at least one memory, the at least one processor configured to:
receive, by an artificial neural network (ANN) model, a set of tokens corresponding to an input;
process, by a token interaction block of the ANN model, the set of tokens according to each channel of the input to generate a spatial mixture of a set of features for each channel of the input;
generate, by a feed forward network (FFN) block of the ANN model, a mixture of channel features based on the spatial mixture of the set of features for each channel of the input;
determine, by an attention block of the ANN model, a set of attended features of the mixture of channel features according to a set of attention weights; and
generate, by the ANN model, an inference based on the set of attend features of the mixture of channel features.

10. The apparatus of claim 9, in which the at least one processor is further configured to process the set of tokens corresponding to the input using a depth-wise convolution to generate the spatial mixture of the set of features.

11. The apparatus of claim 9, in which the at least one processor is further configured to process the spatial mixture of the set of features using a point-wise convolution to generate the mixture of channel features.

12. The apparatus of claim 9, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).

13. The apparatus of claim 9, in which the input comprises an image, an audio signal, or a textual input.

14. The apparatus of claim 13, in which the at least one processor is further configured to divide the image into a set of patches, the set of tokens corresponding to the set of patches of the image.

15. The apparatus of claim 9, in which the inference is a classification of the input.

16. The apparatus of claim 9, in which the at least one processor is further configured to reshape the mixture of channel features to form a one-dimensional sequence of mixed features.

17. A non-transitory computer-readable medium having program code recorded thereon, the program code executed by a processor and comprising:
program code to receive, by an artificial neural network (ANN) model, a set of tokens corresponding to an input;
program code to process, by a token interaction block of the ANN model, the set of tokens according to each channel of the input to generate a spatial mixture of a set of features for each channel of the input;
program code to generate, by a feed forward network (FFN) block of the ANN model, a mixture of channel features based on the spatial mixture of the set of features for each channel of the input;
program code to determine, by an attention block of the ANN model, a set of attended features of the mixture of channel features according to a set of attention weights; and
program code to generate, by the ANN model, an inference based on the set of attend features of the mixture of channel features.

18. The non-transitory computer-readable medium of claim 17, in which the program code comprises program code to process the set of tokens corresponding to the input using a depth-wise convolution to generate the spatial mixture of the set of features.

19. The non-transitory computer-readable medium of claim 17, in which the program code comprises program code to process the spatial mixture of the set of features using a point-wise convolution to generate the mixture of channel features.

20. The non-transitory computer-readable medium of claim 17, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).

21. The non-transitory computer-readable medium of claim 17, in which the input comprises an image, an audio signal, or a textual input.

22. The non-transitory computer-readable medium of claim 21, in which the program code comprises program code to divide the image into a set of patches, the set of tokens corresponding to the set of patches of the image.

23. The non-transitory computer-readable medium of claim 17, in which the program code comprises program code to reshape the mixture of channel features to form a one-dimensional sequence of mixed features.

24. An apparatus comprising:
means for receiving, by an artificial neural network (ANN) model, a set of tokens corresponding to an input;
means for processing, by a token interaction block of the ANN model, the set of tokens according to each channel of the input to generate a spatial mixture of a set of features for each channel of the input;
means for generating, by a feed forward network (FFN) block of the ANN model, a mixture of channel features based on the spatial mixture of the set of features for each channel of the input;
means for determining, by an attention block of the ANN model, a set of attended features of the mixture of channel features according to a set of attention weights; and
means for generating, by the ANN model, an inference based on the set of attend features of the mixture of channel features.

25. The apparatus of claim 24, further comprising means for processing the set of tokens corresponding to the input using a depth-wise convolution to generate the spatial mixture of the set of features.

26. The apparatus of claim 24, further comprising means for processing the spatial mixture of the set of features using a point-wise convolution to generate the mixture of channel features.

27. The apparatus of claim 24, in which the ANN model comprises a vision transformer, a bi-directional encoder representations from transformers (BERT), a robustly optimized BERT approach (ROBERTa)-based transformer, an XLNet-based transformer, Transformer-XL-based transformer, or a generative pre-trained transformer (GPT).

28. The apparatus of claim 24, in which the input comprises an image, an audio signal, or a textual input.

29. The apparatus of claim 28, further comprising means for dividing the image into a set of patches, the set of tokens corresponding to the set of patches of the image.

30. The apparatus of claim 24, further comprising means for reshaping the mixture of channel features to form a one-dimensional sequence of mixed features.
